(19) United States
(12) Patent Application Publication
(10) Pub. No.: US 2024/0209531 A1
(43) Pub. Date: Jun. 27, 2024

(54) ELECTRODE FOR GENERATING CHLORINE

(71) Applicants: ISHIFUKU METAL INDUSTRY CO., LTD., Tokyo (JP); TOTO LTD., Fukuoka (JP)

(72) Inventors: Kenji Matsumae, Saitama (JP); Satoru Matsumoto, Saitama (JP); Hiroaki Amemori, Fukuoka (JP); Satoru Matsumoto, Fukuoka (JP)

(73) Assignees: ISHIFUKU METAL INDUSTRY CO., LTD., Tokyo (JP); TOTO LTD., Fukuoka (JP)

(21) Appl. No.: 18/390,714

(22) Filed: Dec. 20, 2023

(30) Foreign Application Priority Data
Dec. 22, 2022 (JP) 2022-205271

(51) Int. Cl. C25B 11/097; C25B 1/26; C25B 11/063; C25B 11/093

(52) U.S. Cl. CPC C25B 11/097; C25B 1/26; C25B 11/063; C25B 11/093

(57) ABSTRACT

Disclosed herein are an electrode for generating chlorine comprising in sequence a substrate consisting of titanium or titanium-based alloy, an intermediate layer, and a catalyst layer, and a method for generating chlorine by electrolyzing dilute salt water in an electrolytic cell comprising at least a pair of said electrodes with an anode and a cathode. The intermediate layer comprises a porous platinum coating and titanium oxide provided on the substrate, the catalyst layer, in particular, consists of 2 mol % to 24 mol % platinum, 41 mol % to 49 mol % iridium oxide, and 35 mol % to 49 mol % tantalum oxide in metal equivalent. The electrode and the method with high chlorine generation efficiency and longer life time are provided under the condition of electrolyzing dilute salt water while repeatedly switching the polarity of anode and cathode every 5 to 60 seconds at a current density of 0.05 to 0.25 A·cm⁻².

### BACKGROUND OF THE INVENTION

### 1. Field of the Invention

The present invention relates to an electrode for generating chlorine, which is used as an anode in dilute salt water such as tap water and which is useful for producing electrolytic water having bactericidal activity, and more specifically relates to an electrode for generating chlorine, which achieves high chlorine generation efficiency under conditions where polarity is switched at short intervals at a relatively high current density, and which has a longer service life.

### 2. Description of Related Art

In apparatuses for generating bactericidal water by electrolyzing tap water, and especially apparatuses installed in domestic appliances, in order to reduce the size of an apparatus so as to be able to be installed in a domestic appliance, there is a strong need for a chlorine-generating electrode which achieves high chlorine generation efficiency under conditions where polarity is switched at short intervals at a relatively high current density, and which has a longer service life.

A seawater electrolyzing electrode comprising a porous platinum coating layer on a titanium or titanium-based alloy electrode substrate having a titanium oxide layer and, supported on the platinum coating layer, an electrode catalyst layer that is a composite material of 30 to 65 mol % of iridium oxide, 10 to 40 mol % of tantalum oxide and 25 to 60 mol % of platinum, has been proposed (see JP Hei 08 (1996)-170187 A). This proposed electrode has advantages such as achieving high chlorine generation efficiency and being stable even in a low potential environment during acid washing, but has problems such as the service life of the electrode being insufficient under conditions whereby polarity is switched at short intervals at a relatively high current density.

In apparatuses for generating bactericidal water by directly electrolyzing tap water, the distance between electrodes is often set to 2 mm or less because tap water has high electrical resistance. In addition, in cases where the distance between electrodes is 2 mm or less, switching polarity at short intervals in order to remove scale components generated on the cathode side is preferred from the perspective of being maintenance-free. In addition, in order to reduce the size of such apparatuses, there is a strong need for a chlorine-generating electrode which achieves high chlorine generation efficiency at a high current density and which has a longer service life.

That is, the present invention addresses the problem of developing an electrode for generating chlorine from dilute salt water such as tap water, wherein the electrode achieves high chlorine generation efficiency under conditions whereby polarity is switched at short intervals at a relatively high current density, and has a longer service life.

### BRIEF SUMMARY OF THE INVENTION

As a result of diligent research carried out in order to solve the problem mentioned above, the inventors of the present invention discovered an electrode for generating chlorine from dilute salt water such as tap water, wherein the electrode achieves high chlorine generation efficiency under conditions whereby polarity is switched at short intervals at a relatively high current density and has a longer service life as a result of a prescribed mixing ratio (Pt:Ir:Ta=2 to 24 mol %: 41 to 49 mol %: 35 to 49 mol %) in a catalyst layer which consists of platinum, iridium oxide and tantalum oxide and which is formed on an intermediate layer, and thereby completed the present invention.

Provided by the present specification is:
an electrode for generating chlorine, which comprises a substrate consisting of titanium or a titanium-based alloy, an intermediate layer, and a catalyst layer in the stated order, wherein
the intermediate layer comprises a porous platinum coating and titanium oxide provided on the substrate,
the catalyst layer consists of 2 mol % to 24 mol % of platinum, 41 mol % to 49 mol % of iridium oxide, and 35 mol % to 49 mol % of tantalum oxide in terms of metal amount,
said electrode for generating chlorine being used to generate chlorine by electrolyzing dilute salt water while repeatedly switching the polarity of an anode and a cathode every 5 to 60 seconds at a current density of 0.05 to 0.25 A·cm⁻².

The electrode disclosed in the present specification can provide an electrode for generating chlorine, which achieves high chlorine generation efficiency under conditions where polarity is switched at short intervals at a relatively high current density, and which has a longer service life.

As another aspect, the present specification discloses the following method:

A method for generating chlorine by electrolyzing dilute salt water in an electrolytic cell comprising at least a pair of electrodes comprising an anode and a cathode,
each of said electrodes comprising a substrate made of titanium or a titanium-based alloy, an intermediate layer, and a catalyst layer, in that order, wherein
the intermediate layer comprises a porous platinum coating and titanium oxide provided on the substrate,
the catalyst layer consists of 2 mol % to 24 mol % of platinum, 41 mol % to 49 mol % of iridium oxide, and 35 mol % to 49 mol % of tantalum oxide in terms of metal amount,
and said method comprises a step wherein dilute salt water is electrolyzed in said electrolytic cell to generate chlorine by repeatedly switching the polarity of the anode and the cathode every 5 to 60 seconds at a current density of 0.05 to 0.25 A·cm⁻².

### DETAILED DESCRIPTION OF INVENTION

### <Electrode Disclosed in Present Specification>

In the electrode mentioned above, switching polarity means reversing the polarity of a voltage applied between two electrodes whenever the electrolysis time reaches a prescribed period of time (for example, 5 to 60 seconds). In a case where electrolysis is carried out intermittently, the polarity of a voltage applied between two electrodes is reversed whenever the total electrolysis time (cumulative electrolysis time) reaches a prescribed period of time (for example, 5 to 60 seconds).

The catalyst layer in the electrode of the present invention consists of 2 mol % to 24 mol % of platinum, 41 mol % to 49 mol % of iridium oxide, and 35 mol % to 49 mol % of tantalum oxide in terms of metal amount.

In the electrode for generating chlorine, which electrolyzes dilute salt water while repeatedly switching the polarity of an anode and a cathode every 5 to 60 seconds at a current density of 0.05 to 0.25 A·cm⁻², durability deteriorates if the concentration values of iridium oxide and tantalum oxide in the catalyst layer are lower than the ranges mentioned above. In addition, chlorine generation efficiency deteriorates if the concentration values of iridium oxide and tantalum oxide in the catalyst layer are higher than the ranges mentioned above. Here, dilute salt water means water having a chlorine ion concentration of 5 to 100 ppm.

The catalyst layer preferably consists of 4 mol % to 23 mol % of platinum, 42 mol % to 48 mol % of iridium oxide, and 35 mol % to 48 mol % of tantalum oxide in terms of metal amount. The catalyst layer more preferably consists of 4 mol % to 21 mol % of platinum, 42 mol % to 48 mol % of iridium oxide, and 37 mol % to 48 mol % of tantalum oxide in terms of metal amount.

Detailed explanations will now be given of the electrode of the present invention, a method for producing same, and a method for generating chlorine from dilute salt water using said electrode, although said electrode and methods are not limited to these explanations.

### <Substrate>

Titanium and titanium-based alloys can be given as examples of materials of the substrate used in the present invention. A corrosion-resistant electrically conductive alloy comprising a mainly titanium is used as a titanium-based alloy, examples of which include Ti-based alloys commonly used as electrode materials, which comprise combinations such as Ti—Ta—Nb, Ti—Pd, Ti—Zr and Ti—Al. These electrode materials can be used as substrates after being processed into desired shapes, such as plates, perforated plates, rods and mesh boards.

### <Substrate Pre-Treatment>

The substrate mentioned above is preferably pre-treated in advance, as is routinely carried out in this technical field. Specific preferred examples of this type of pre-treatment include those given below.

First, the surface of a substrate comprising titanium or a titanium-based alloy is cleaned with an alcohol, acetone, or the like and/or degreased by means of electrolysis in an alkaline solution using a conventional method, and then acid-treated using hydrofluoric acid having a hydrogen fluoride concentration of 1 to 20 wt % or a mixed acid comprising hydrofluoric acid and another acid such as nitric acid or sulfuric acid. An oxide film is removed from the surface of the substrate by this acid treatment. In addition, crystal grain boundaries at the surface of the substrate in particular are etched by this acid treatment. Moreover, it is preferable for an oxide film to be completely removed from the surface of the substrate, but the substrate is not limited to one from which an oxide film has been completely removed as long as this is in line with the purpose of the present invention. Depending on the state of the substrate surface, for example, this acid treatment can be carried out at a temperature between normal temperature and approximately 40° C. for a period of between 1 minute and 15 minutes. Moreover, a blasting treatment may also be carried out in order to sufficiently roughen the surface.

### <Titanium Hydride Formation Treatment>

Next, the surface of the substrate is brought into contact with concentrated sulfuric acid (a sulfuric acid treatment) so as to finely roughen portions of the substrate surface other than crystal grain boundaries (portions within crystal grains) in particular into a protruding shape and form a thin layer of titanium hydride on the surface of the titanium substrate.

The concentrated sulfuric acid used generally has a concentration of 40 to 80 wt %, and preferably 50 to 60 wt %, and sodium sulfate, other sulfates, and the like, may be added to this concentrated sulfuric acid if necessary in order to stabilize the treatment. Contact with the concentrated sulfuric acid can generally be carried out by immersing the titanium substrate in a bath of concentrated sulfuric acid, and in such a case, the bath temperature is generally approximately 100° C. to approximately 150° C., and preferably approximately 110° C. to approximately 130° C., and the immersion time is generally approximately 0.5 minutes to approximately 10 minutes, and preferably approximately 1 minute to approximately 3 minutes.

By carrying out the sulfuric acid treatment described above, portions of the substrate surface other than crystal grain boundaries (portions within crystal grains) can be finely roughened into a protruding shape, and an extremely thin coating film of titanium hydride can be formed on the surface of the substrate. The sulfuric acid-treated titanium substrate is removed from the sulfuric acid bath and is then preferably rapidly cooled in an inert gas atmosphere such as nitrogen or argon so as to lower the surface temperature of the titanium substrate to approximately 60° C. or lower. A large amount of cold water should be used for this rapid cooling as well as for cleaning.

Therefore, of the substrate in the present invention, the substrate surface that is in contact with the intermediate layer may be finely roughened into a protruding shape.

The substrate on which the extremely fine coating film layer of titanium hydride has been formed in the manner described above is then immersed in dilute hydrofluoric acid or a dilute aqueous solution of a fluoride (for example, an aqueous solution of sodium fluoride, potassium fluoride, or the like) in order to grow the titanium hydride coating film and make the coating film more uniform and stable. The concentration of hydrogen fluoride in the dilute hydrofluoric acid or dilute aqueous solution of a fluoride used here can generally be 0.05 to 3 wt %, and preferably 0.3 to 1 wt %, and the temperature when immersing the substrate in these solutions can generally be 10 to 40′C, and preferably 20 to 30° C. This treatment can be carried out until a uniform titanium hydride coating film having a thickness of generally 0.5 to 10 μm, and preferably 1 to 3 μm, is formed on the surface of the substrate. Because this titanium hydride (TiH_{y}, where y is a number between 1.5 and 2) has a color that is grayish brown to blackish brown depending on the degree of hydrogenation, generation of a titanium hydride coating film having a thickness within the range mentioned above can be controlled by correlating changes in the color tone of the substrate surface over time with the lightness of a standard color source.

### <Formation of Porous Platinum Coating>

The substrate whose surface has been roughened and coated with a titanium hydride coating film is subjected to a treatment such as washing with water at an appropriate time, after which a porous platinum coating is formed on the surface. This porous platinum coating can generally be formed by electroplating. Examples of compositions of plating baths able to be used for this electroplating include acidic and alkaline plating baths obtained by dissolving a platinum compound such as H₂PtCl₆, (NH4)₂PtCl₆, K₂PtCl₆ or Pt(NH₃)₂(NO₂)₂ in a sulfuric acid solution (pH 1 to 3) or an aqueous solution of ammonia so that the concentration in terms of platinum amount is 2 to 20 g/L, and especially 5 to 10 g/L, and adding a small amount of sodium sulfate (in the case of an acidic bath) or sodium sulfite or sodium sulfate (in the case of an alkaline bath) if necessary in order to stabilize the bath.

Platinum electroplating using a plating bath having such a composition is preferably carried out at a relatively low temperature of approximately 30° C. to approximately 60° C. using a high speed plating method such as so-called strike plating in order to minimize degradation of the titanium hydride coating film formed on the substrate surface. By carrying out this electroplating, a porous platinum coating having excellent physical adhesive strength can be formed on the titanium hydride coating film on the substrate.

Here, the degree of “porosity” is specified by the “apparent density of the platinum coating”. The apparent density of the porous platinum coating can be 8 to 19 g/cm³, and preferably 12 to 18 g/cm³. If the apparent density of the porous platinum coating is less than 8 g/cm³, the bonding strength of the platinum decreases and the porous platinum coating readily detaches, but if the apparent density of the porous platinum coating exceeds 19 g/cm³, it is difficult to stably support platinum and iridium oxide through pyrolysis, which is described later. The apparent density of the porous platinum coating can be controlled by, for example, adjusting the substrate pre-treatment conditions, the composition of the platinum plating bath and/or plating conditions (current density, current wave form, and so on) over time. Moreover, in a case where a platinum coating having a higher porosity is to be obtained, it is possible to form a porous platinum coating and then increase the porosity using a chemical or electrochemical method.

In addition, this platinum electroplating is generally continued until the amount of platinum coating on the substrate is at least 0.2 mg/cm² or more. If the amount of platinum coating is less than 0.2 mg/cm², the titanium hydride coating film portion becomes excessively oxidized when a firing treatment described later is carried out, and electrical conductivity tends to decrease. The upper limit of the amount of platinum coating is not particularly limited, but a higher amount than necessary does not achieve a commensurately higher effect, and is actually uneconomic, and a platinum coating amount of 5 mg/cm² or less is therefore generally sufficient. A preferred platinum coating amount is 1 to 3 mg/cm². Here, the platinum coating amount in the porous platinum coating is an amount determined in the following way using fluorescence X-Ray analysis. That is, plating amounts of platinum at various thicknesses formed using the method described above on the pre-treated substrate are quantified using a wet analysis method and fluorescence X-Ray analysis, analyzed values from both methods are plotted on graphs to prepare standard calibration curves, and an actual sample is then subjected to fluorescence X-Ray analysis, and the coated platinum amount is determined from this analyzed value and the standard calibration curve. In addition, the density (8 (g/cm³)) of the platinum coating is determined as 8=w/t from the platinum coating amount (w (g/cm²)) determined in the manner described above and the thickness (t (cm)) of the platinum coating, which is determined from a cross-sectional microscope observation of the sample.

### <Formation of Titanium Oxide>

The substrate on which the porous platinum coating has been provided is then calcinated in air. By carrying out this calcining, the layer of the titanium hydride coating film below the platinum coating is pyrolyzed, thereby causing almost all of the titanium hydride in the layer of the titanium hydride coating film to revert to a metal, and titanium in those parts of the substrate which correspond to porous portions of the titanium coating that are not coated with platinum can be converted into a titanium oxide in a lower oxidation state.

This calcining generally be carried out by heating for a period of approximately 10 minutes to 4 hours at a temperature of approximately 300° C. to approximately 600° C., and preferably approximately 300° C. to approximately 400° C. In this way, extremely thin electrically conductive titanium oxide is formed on the surface of the substrate. The thickness of this titanium oxide is generally 100 to 1000 Å, and preferably 200 to 600 Å, and the composition of the titanium oxide is TiOx, where x is generally such that 1<x<2, and preferably 1.9<x<2. As an alternative process, a substrate on which platinum has been dispersed and coated may be directly subjected to the following step without carrying out the calcining treatment described above. In this case, the layer of titanium hydride coating film on the substrate surface is converted into metal and titanium oxide in a lower oxidation state during a pyrolysis treatment in a subsequent step. By constituting in this way, it is possible to maintain adhesive strength between the porous platinum coating and the substrate, form electrically conductive titanium oxide (a passivation film) and increase chemical strength.

Therefore, the intermediate layer in the present invention preferably comprises the porous platinum coating and titanium oxide provided on the substrate. However, the titanium hydride below the platinum coating on the substrate surface need not be completely metallized, and titanium in those parts of the substrate which correspond to porous portions of the titanium coating that are not coated with platinum need not be completely converted into a titanium oxide in a lower oxidation state, as long as this is in line with the purpose of the present invention.

### <Formation of Catalyst Layer>

Next, solutions containing a platinum compound, an iridium compound and a tantalum compound are coated on the substrate on which the porous platinum coating has been provided, and the substrate is then dried and fired to form a layer comprising platinum-iridium oxide-tantalum oxide.

The platinum compound, iridium compound and tantalum compound used here are compounds able to be converted into platinum, iridium oxide and tantalum oxide, respectively, when decomposed under conditions described below, and examples of the platinum compound include dinitrodiammine platinum, chloroplatinic acid and platinum chloride, with chloroplatinic acid being particularly preferred. In addition, examples of the iridium compound include chloroiridic acid, iridium chloride and potassium iridium chloride, with chloroiridic acid being particularly preferred. Furthermore, examples of the tantalum compound include tantalum chloride and tantalum ethoxide.

Meanwhile, lower alcohols are preferred as solvents for dissolving these platinum compounds, iridium compounds and tantalum compounds, with methanol, ethanol, propanol, butanol and mixtures of these able to be advantageously used. Moreover, dinitrodiammine platinum cannot be directly dissolved in lower alcohols, and is therefore preferably first dissolved in an aqueous solution of nitric acid, adjusted to a concentration of 250 to 450 g/L in terms of platinum metal amount, and then dissolved in a lower alcohol.

The total metal concentration of the platinum compound, iridium compound and tantalum compound in the lower alcohol solution can generally be 20 to 200 g/L, and preferably 40 to 150 g/L. If this metal concentration is less than 20 g/L, catalyst-supporting efficiency deteriorates, but if this metal concentration exceeds 200 g/L, aggregation of the catalyst tends to occur, which causes problems in terms of catalytic activity, supporting strength, uniformity of supported amount, and so on.

In addition, the relative usage proportions of the platinum compound, iridium compound and tantalum compound are such that the proportion of the platinum compound is 2 mol % to 24 mol %, the proportion of the iridium compound is 41 mol % to 49 mol %, and the proportion of the tantalum compound is 35 mol % to 49 mol % in terms of metallic Pt, metallic Ir and metallic Ta amounts.

The solutions containing the platinum compound, iridium compound and tantalum compound are coated on the substrate on which the porous platinum coating has been provided, and the substrate is then dried at a temperature of approximately 20° C. to approximately 150° C., and then calcinated in an oxygen-containing gas atmosphere such as air. The calcining can generally be carried out by heating at a temperature of approximately 450° C. to approximately 650° C., and preferably approximately 500° C. to approximately 600° C., using a suitable heating oven, such as an electric oven, a gas oven or an infrared oven. The heating time can generally be between 3 minutes and 30 minutes, depending on the size of the substrate to be calcinated. By carrying out this calcining, a layer comprising platinum-iridium oxide-tantalum oxide can be formed and supported.

In addition, in a case where a sufficient amount of a layer comprising platinum-iridium oxide-tantalum oxide cannot be formed and supported by a single supporting operation, the procedure described above comprising coating a solution, drying and calcining can be repeated a prescribed number of times.

Proportions of components in the layer comprising platinum-iridium oxide-tantalum oxide (electrode catalyst layer/composite material) are such that the proportion of platinum is 2 mol % to 24 mol %, the proportion of the iridium compound is 41 mol % to 49 mol %, and the proportion of the tantalum compound is 35 mol % to 49 mol % in terms of metallic Pt, metallic Ir and metallic Ta amounts.

In this way, it is possible to produce an electrode constituted from “catalyst layer (outer layer)/intermediate layer (porous platinum coating-titanium oxide)/substrate”. That is, titanium oxide is formed on those parts of the substrate surface which correspond to porous portions of the titanium coating that are not coated with platinum.

<Method for Generating Chlorine from Dilute Salt Water Using the Aforementioned Electrode>

In this method for generating chlorine, dilute salt water is electrolyzed in an electrolytic cell comprising the aforementioned electrode or an electrode of these preferred embodiments as a pair of electrodes comprising an anode and a cathode.

In this electrolysis system, the type, shape and details of the electrolysis device and the electrolytic cell, and the arrangement of electrodes in the electrolytic cell, are not particularly limited as long as these are in line with the purpose of the present invention, and can be based on features commonly used in this technical field. In this method, dilute salt water is supplied to an electrolytic cell having the aforementioned electrodes while the polarity of an anode and a cathode is repeatedly switched every 5 to 60 seconds at a current density of 0.05 to 0.25 A·cm⁻², and chlorine is generated through contact between the dilute salt water and the electrode.

Next, a production method and characteristics of the electrode of the present invention will be explained in greater detail through the use of working examples.

### Working Examples

Working Examples 1 to 3 and Comparative Examples 1 and 2 A substrate obtained by immersing a JIS 1 type titanium plate material (t0.5 mm×100 mm×100 mm) in acetone, degreasing by means of ultrasonic wave cleaning for 10 minutes, treating for 2 minutes with a 8 wt % aqueous solution of hydrofluoric acid at 20° C., and then treating for 3 minutes with a 60 wt % aqueous solution of sulfuric acid at 120° C. was used as the substrate.

Next, the substrate was removed from the aqueous sulfuric acid solution and rapidly cooled by being sprayed with cold water in a nitrogen atmosphere. The substrate was then immersed for 2 minutes in a 0.3 wt % aqueous solution of hydrofluoric acid at 20° C., and then washed with water.

After being washed with water, the substrate was plated for approximately 6 minutes at 30 mA/cm² in a platinum plating bath prepared at 50° C. by dissolving dinitrodiammine platinum in a sulfuric acid solution and adjusting to attain a platinum content of 5 g/L and a pH of approximately 2, thereby forming a porous platinum coating having an apparent density of 16 g/cm³ and an electrodeposition amount of 1.7 mg/cm² on the substrate.

The substrate was dried and then calcinated for 1 hour in air at 400° C.

Next, a butanol solution of chloroplatinic acid adjusted to a platinum concentration of 70 g/L, a butanol solution of chloroiridic acid adjusted to an iridium concentration of 100 g/L and a butanol solution of tantalum ethoxide adjusted to a tantalum concentration of 200 g/L were weighed out so that the compositional ratio in terms of Pt—Ir-Ta metal amounts were molar percentages shown in Table 1, and the solutions were diluted with butanol so that the total concentration of metal components in terms of metal amount was 75 g/L, thereby producing an electrode catalyst layer coating solution having a compositional ratio in terms of metal amount shown in Table 1. 250 μL of the coating solution was weighed out using a pipette and coated on the substrate on which the porous platinum coating had been provided, the substrate was tilted using tweezers so as to spread the solution across the whole surface of the substrate, and the substrate was then dried at room temperature and then calcinated for 10 minutes in air at 530° C. This coating/drying/calcining procedure was repeated four times to produce electrodes of Working Examples 1 to 3 and Comparative Examples 1 and 2.

Chlorine generation efficiency was evaluated in the manner described below using the electrodes produced in Working Examples 1 to 3 and Comparative Examples 1 and 2. Tap water (Sõka City water; chlorine ion concentration: 18 ppm) was used as an electrolyte solution. Electrolysis was carried out at an inter-electrode distance of 2 mm, a flow rate of 0.3 L/min and a current density of 0.12 A/cm² while the polarity was switched every 30 seconds, 10 mL of electrolyzed liquid was sampled, the free chlorine concentration was measured using a DPD method, and the chlorine generation efficiency was calculated.

Service life was evaluated in the manner described below using the electrodes produced in Working Examples 1 to 3 and Comparative Examples 1 and 2.

Tap water (Sõka City water; chlorine ion concentration: 18 ppm) was used as an electrolyte solution. An electrolysis test was carried out at an interelectrode distance of 2 mm, a flow rate of 0.3 I/min and a current density of 0.12 A/cm² while the polarity was switched every 30 seconds. The point at which the chlorine generation efficiency became 1% or less was assessed as being the service life.

Data obtained using Working Examples 1 to 3 and Comparative Examples 1 and 2 are shown in Table 1.

TABLE 1

| | | | | | Chlorine | |
|---|---|---|---|---|---|---|
| | Electrode catalyst layer | | | | generation | |
| | compositional ratio (mol %) | | | Intermediate | efficiency | Service life |
| | Pt | Ir | Ta | layer | (%) | (hours) |
| Working | 15 | 45 | 40 | Porous | 2.9 | 400 |
| Example 1 | | | | platinum | | |
| Working | 22 | 43 | 35 | coating layer- | 2.8 | 220 |
| Example 2 | | | | titanium oxide | | |
| Working | 5 | 48 | 47 | | 3.0 | 460 |
| Example 3 | | | | | | |
| Comparative | 22.5 | 22.5 | 55 | | 2.2 | 150 |
| Example 1 | | | | | | |
| Comparative | 35 | 40 | 25 | | 2.4 | 150 |
| Example 2 | | | | | | |

The electrodes of Working Examples 1 to 3 had a chlorine generation efficiency of 2.8%, which was higher than that of the electrodes of Comparative Examples 1 and 2, and had a service life of 220 hours or longer, which was longer than that of the electrodes of Comparative Examples 1 and 2.

From these results, it can be understood that good characteristics are exhibited by an electrode in which an intermediate layer comprises a porous platinum coating and titanium oxide provided on the substrate, and a catalyst layer comprises an electrode catalyst layer that consists of 2 mol % to 24 mol % of platinum, 41 mol % to 49 mol % of iridium oxide, and 35 mol % to 49 mol % of tantalum oxide in terms of metal amount.

1. An electrode for generating chlorine, which comprises a substrate consisting of titanium or a titanium-based alloy, an intermediate layer, and a catalyst layer in the stated order, wherein
the intermediate layer comprises a porous platinum coating and titanium oxide provided on the substrate,
the catalyst layer consists of 2 mol % to 24 mol % of platinum, 41 mol % to 49 mol % of iridium oxide, and 35 mol % to 49 mol % of tantalum oxide in terms of metal amount,
said electrode for generating chlorine being used to generate chlorine by electrolyzing dilute salt water while repeatedly switching the polarity of an anode and a cathode every 5 to 60 seconds at a current density of 0.05 to 0.25 A·cm⁻².

2. The electrode for generating chlorine of claim 1, wherein the catalyst layer consists of 4 mol % to 21 mol % of platinum, 42 mol % to 48 mol % of iridium oxide, and 37 mol % to 48 mol % of tantalum oxide in terms of metal amount.

3. A method for generating chlorine by electrolyzing dilute salt water in an electrolytic cell comprising at least a pair of electrodes comprising an anode and a cathode,
each of said electrodes comprising a substrate made of titanium or a titanium-based alloy, an intermediate layer, and a catalyst layer, in that order, wherein
the intermediate layer comprises a porous platinum coating and titanium oxide provided on the substrate,
the catalyst layer consists of 2 mol % to 24 mol % of platinum, 41 mol % to 49 mol % of iridium oxide, and 35 mol % to 49 mol % of tantalum oxide in terms of metal amount,
and said method comprises a step wherein dilute salt water is electrolyzed in said electrolytic cell to generate chlorine by repeatedly switching the polarity of the anode and the cathode every 5 to 60 seconds at a current density of 0.05 to 0.25 A·cm⁻².

4. The method for generating chlorine of claim 3, wherein the catalyst layer consists of 4 mol % to 21 mol % of platinum, 42 mol % to 48 mol % of iridium oxide, and 37 mol % to 48 mol % of tantalum oxide in terms of metal amount.
